(19) United States
(12) Patent Application Publication
(10) Pub. No.: US 2003/0014751 A1
(43) Pub. Date: Jan. 16, 2003

(54) Method of controlling levels used to restrict video reproduction by video reproducing system and apparatus for controlling the same

(75) Inventor: Seung-Kyu Paek, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/082,173

(22) Filed: Feb. 26, 2002

(30) Foreign Application Priority Data
Jul. 13, 2001 (KR) 2001-42345

(51) Int. Cl. H04N 7/16

(52) U.S. Cl. 725/30; 725/25

(57) ABSTRACT

The prevent invention provides an apparatus and a method of restricting the reproduction of a video according to levels of a video reproducing system. More particularly, a digital video disc (DVD) system of the present invention reproduces a video according to a parental level corresponding to an input password. Otherwise, the DVD system reproduces the video from a DVD title according to a default parental level. An authorized user sets one or more passwords corresponding to parental levels in a DVD system. The DVD system verifies an input password against the one or more passwords to automatically select the parental level. If the user's input password does not correspond to the one or more passwords set by the authorized user, the DVD system automatically elects the default parental level. Therefore, even if the authorized user doesn't reset the parental level after setting the parental level to an adult level, the DVD system of the present invention prevents children or teenagers from accidentally viewing movies corresponding to the adult level. The present invention allows more convenient use of the parental control function made available in a DVD system.

### CROSS-REFERENCE TO RELATED APPLICATIONS

This application claims the benefit of Korean Application No. 2001-42345, filed Jul. 13, 2001, in the Korean Industrial Property Office, the disclosure of which is incorporated herein by reference.

### BACKGROUND OF THE INVENTION

1. Field of the Invention

The present invention relates to a method of restricting the reproduction of a video according to levels of a video reproducing system and an apparatus for restricting the same. More particularly, the present invention relates to a method and an apparatus for controlling parental levels for restricting the reproduction of a video by a video reproducing system, such as a digital video disc (DVD) system, in which passwords are set according to the parental levels desired in the DVD system and the reproduction of a DVD title is controlled according to a viewing level corresponding to an input password.

2. Description of the Related Art

DVDs have a higher recording data density and picture quality than conventional video media such as compact discs (CDs). In addition, a variety of functions can be incorporated into DVDs and DVD systems. For example, a DVD system can be set with a predetermined level (“parental level”) which restricts the reproduction of a DVD. In other words, a DVD system reproduces a movie or scenes from a movie corresponding to the parental level set by an authorized user. The parental level is set according to a program chain of a movie recorded in a DVD title.

In general, parental levels are classified according to contents of video scenes in a DVD title. For example, parental levels are classified into a children level, a teenager level, and an adult level. A level 1, for example, may be a lowest parental level corresponding to the children level, while a higher parental level, such as 3, may correspond to the adult level. If an authorized user selects the children level, a DVD system selects and reproduces only scenes corresponding to the children level among all scenes recorded in a DVD title. In contrast, if the authorized user selects the adult level, a DVD system reproduces all of the scenes, regardless of their levels, recorded in the DVD title.

In a conventional DVD system, once the DVD system is set with one of the parental levels, the DVD system continues to reproduce a video according to that level until the authorized user manually resets the DVD system with another parental level. For example, if an adult user forgets to reset the parent level from an adult level to a children/teenager level, conventional DVD systems will continue to play a DVD title under the adult level, exposing the children or teenagers to adult level scenes present in the DVD title. That is, with the conventional DVD systems, the adult user must reset the parent level every time a reproduction of a DVD title is terminated.

### SUMMARY OF THE INVENTION

Accordingly, it is an object of the present invention to provide an apparatus and a method of controlling parental levels for restricting the reproduction of a video by a video reproducing system, in which one or more passwords are set corresponding to the parental levels, and the video reproducing system automatically converts a viewing level to a default level after reproducing a DVD title according to the viewing level (parental level) corresponding to an input password.

Additional objects and advantages of the invention will be set forth in part in the description which follows and, in part, will be obvious from the description, or may be learned by practice of the invention.

To achieve the above and other objects of the present invention, there is provided a method of controlling levels for restricting the reproduction of a video by a video reproducing system so as to restrict viewing of a part or all of the video depending on a user's age. The method includes setting one or more passwords corresponding to a plurality of levels for a restricted viewing of a video, checking an input password with the one or more passwords prior to reproducing the video, determining a viewing level by searching for the plurality of levels corresponding to the input password, and reproducing the part or all of the video according to the viewing level.

To achieve the above and other objects of the present invention, there is also provided an apparatus for restricting a viewing of a video depending on a user's age. The apparatus includes a memory which stores one or more passwords corresponding to a plurality of levels for restricting a viewing of a video, and a controller which outputs a window to check an input password against the one or more passwords in the memory prior to a reproduction mode, reads information on one or more of the plurality of levels corresponding to the input password to determine a viewing level from the memory, and controls a reproduction of the video according to the viewing level.

### BRIEF DESCRIPTION OF THE DRAWINGS

The above object and advantages of the present invention will become more apparent by describing in detail preferred embodiments thereof with reference to the attached drawings in which:

FIG. 1 is a block diagram a digital video disc (DVD) system employing an apparatus which controls levels for a restricted reproduction of a video by a video reproducing system according to an embodiment of the present invention;

FIG. 2 is a flow chart illustrating a method of controlling levels for a restricted reproduction of a video by a video reproducing system according to an embodiment of the present invention; and

FIG. 3 is a detailed flow chart illustrating operations 203 and 204 shown in FIG. 2.

### DETAILED DESCRIPTION OF THE INVENTION

Reference will now be made in detail to the present preferred embodiments of the present invention, examples of which are illustrated in the accompanying drawings, wherein like reference numerals to like elements throughout.

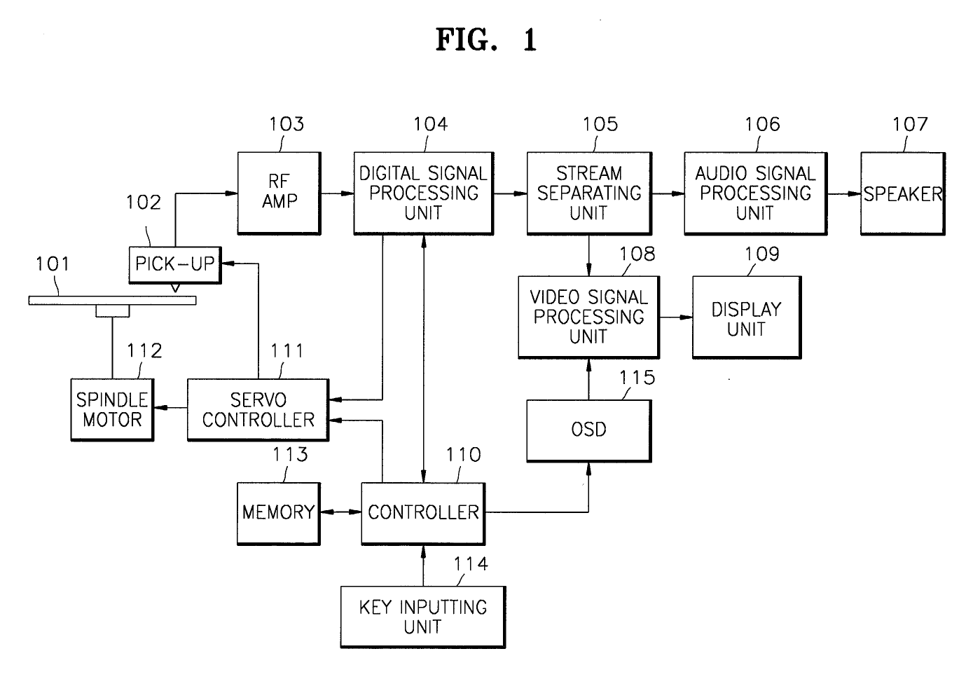

FIG. 1 shows a digital video disc (DVD) system employing an apparatus which controls levels for a restricted reproduction of a video by a video reproducing system. The DVD system includes a DVD 101, a pick-up 102, an RF amplifier 103, a digital signal processing unit 104, a stream separating unit 105, an audio signal processing unit 106, a speaker 107, a video signal processing unit 108, a display unit 109, a controller 110, a servo controller 111, a spindle motor 112, a memory 113, a key inputting unit 114, and an on screen display (OSD) 115.

The servo controller 111 controls the speed of the spindle motor 112 and the movement of the pick-up 102 according to a control command of the controller 110. That is, the servo controller 111 performs servo control for servos such as a tracking servo, a focus servo, a seek servo, and a rotating servo.

The pick-up 102 detects data recorded in the DVD 101 using a mounted semiconductor laser diode and a photo diode, and outputs the detected data to the RF amplifier 103. The RF amplifier 103 amplifies a signal detected in the DVD 101, outputs a servo control signal to the servo controller 111, and outputs a signal processing signal to the digital signal processing unit 104.

The digital signal processing unit 104 converts a signal input to the RF amplifier 103 into digital data, and performs error correction. In particular, the digital signal processing unit 104 extracts parental level information from data, selects reproduction data of a program chain having a level which is the same as or lower than input parental level(s) from the controller 110, and outputs the selected reproduction data to the stream separating unit 105.

The stream separating unit 105 separates audio data, video data, and additional information data from an input reproduction data stream, and outputs the separated data to the audio signal processing unit 106 and the video signal processing unit 108.

The audio signal processing unit 106 decodes input audio data, converts the input audio data into an analog signal, and outputs the analog signal to the speaker 107.

The video signal processing unit 108 decodes input video data and additional information data, synthesizes the decoded video data and additional information data, encodes the synthesized video data according to the format of the display unit 109, and outputs the encoded video data to the display unit 109. In addition, the video signal processing unit 108 also synthesizes an on screen display signal processed in the OSD 115, and outputs the synthesized on screen display signal to the display unit 109.

The memory 113 stores one or more passwords that correspond to parental levels. According to an aspect of the present invention, different passwords may be assigned corresponding to each of the parental levels, and/or a password may be assigned corresponding to a plurality of parental levels.

The controller 110 controls the entire DVD system. In particular, the controller 110 outputs a window, which obtains an input password, prior to a reproduction mode, reads parental level information consistent with the input password from the memory 113, and outputs the read parental level information to the digital signal processing unit 104. Then, the digital signal processing unit 104 only selects data of a program chain having a level which is the same as or lower than the read parental level information from the controller 110, and outputs the selected data to the stream separating unit 105 which performs a signal processing.

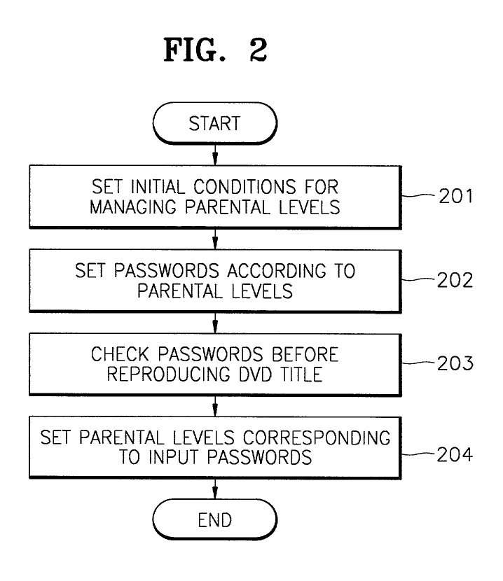

With reference to FIGS. 1 and 2, a method of controlling levels for a restricted reproduction of a video by a video reproducing system according to an embodiment of the present invention is described below.

In operation 201, initial conditions for managing the parental levels in a DVD system are set by using the key inputting unit 114. That is, an authorized user may set a wait period that the DVD system waits prior to changing a current viewing level to a default level as the power is turned off and/or the reproduction of a DVD title is terminated. In addition, the authorized user may also select a parental level that is to be used as the default level. The DVD system uses the default level, for example, in response to the elapsed wait period, entry of an incorrect input password and non-entry of an input password.

In operation 202, one or more passwords may set by a manager of the DVD system (machine selected) corresponding to the parental levels. In such a case, it is necessary to check the manager of the DVD system using a separate procedure. Alternatively, the authorized user may set one or more passwords corresponding to the parental levels and/or a password corresponding to a plurality of parental levels. The set passwords are stored with its parental level information in a parental table of the memory 113.

In operation 203, the DVD system outputs a window which obtains an input password prior to the reproduction of a DVD title. Then, the controller 110 reads the parental level information corresponding to the input password from the memory 113, and outputs the read parental level information to the digital signal processing unit 104.

In operation 204, the digital signal processing unit 114 selects a reproduction signal of a program chain having a level which is the same as or lower than the read parental level information from the controller 110, and outputs the selected reproduction signal.

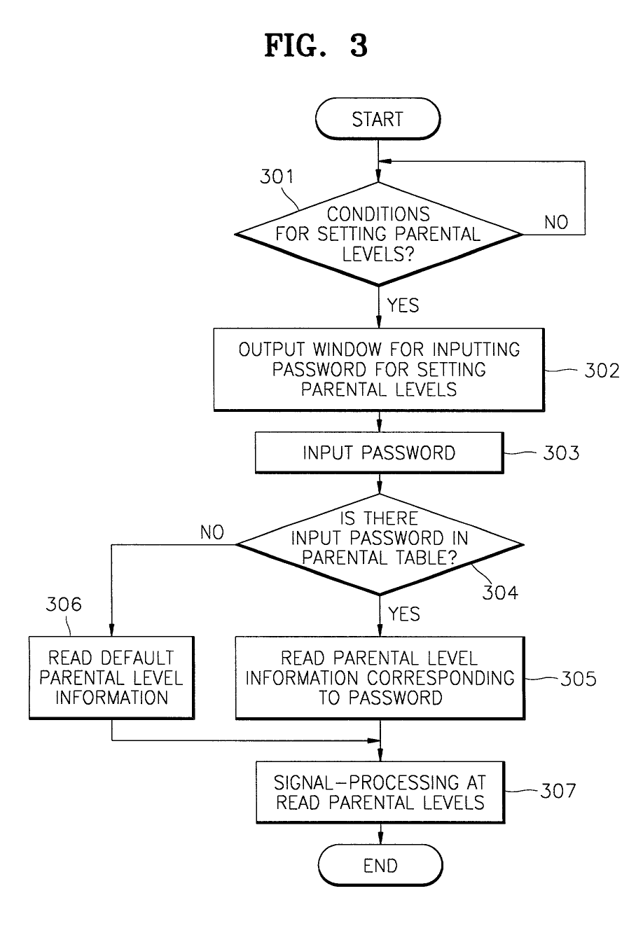

FIG. 3 illustrates the operations 203 and 204 of FIG. 2 in more detail.

In operation 301, the controller 110 determines whether the DVD system corresponds to one of the conditions for setting parental levels. For example, the conditions for setting the parental levels may be programmed as an entry of a command for reproducing a DVD title and as an instance when the power for the DVD system is turned on.

In operation 302, if the DVD system corresponds to the conditions for setting the parental levels, the controller 110 controls the OSD 115 and outputs a window through the display unit 109 so as to allow the authorized user to enter one or more passwords corresponding to the parental levels.

In operation 303, if a user inputs an input password onto the window output through the key inputting unit 114, in operation 304, the controller 110 determines whether the one or more passwords stored in the parental table of the memory 113 are consistent with the input password.

In operation 305, if one of the one or more passwords is consistent with the input password in the parental table, parental level information corresponding to the input password is read from the memory 113. If there are a plurality of parental levels, thus a plurality of parental level information, consistent with the input password, the parental level information at the highest level is read from the memory 113.

However, in operation 306, if there is no password consistent with the input password in the parental table, parental level information set as a default level is read from the memory 113. In other words, the parental level information having a default level, the lowest parental level, is selected.

In operation 307, the controller 110 controls the DVD system such that only a program chain corresponding to the parental level read in the operation 305 or 306 is selected and reproduced.

According to the present invention, passwords are set corresponding to parental levels in a DVD system, and a parental level suitable for a user's age is automatically set according to an input password. In addition, the DVD system of the present invention automatically converts the parental level to a default level even if an authorized user doesn't reset the parental level after setting the parental level to an adult level. Therefore, the DVD system of the present invention is convenient to use, and in particular, the DVD system of the present invention prevents children or teenagers from mistakenly viewing movies corresponding to an adult level.

The present invention may be performed by a method, an apparatus, and a system. When the present invention is performed by software, elements of the present invention may be code segments which perform essential operations of the invention. Programs or code segments may be stored in a processor readable medium and may be transmitted by computer data signals coupled with a carrier signal in a transmission medium or a communication network. The processor readable medium includes a medium capable of storing or transmitting information. Specifically, the processor readable medium includes electronic circuits, semiconductor memory devices, read only memories (ROMs), flash memories, erasable ROMs, floppy discs, optical discs, hard discs, optical fabric media, and radio frequency (RF) networks. The computer data signals include signals which can be propagated onto transmission media, such as electronic network channels, optical fibers, airs, electromagnetic fields, and RF networks.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling levels for restricting a reproduction of a video by a video reproducing system so as to restrict viewing of a part or all of the video depending on a user's age, the method comprising:
setting passwords corresponding to the levels so as to control viewing of the video;
checking an input password against the passwords prior to reproducing the video;
determining a viewing level including searching the levels corresponding to the input password; and
reproducing the video according to the viewing level.

2. The method of claim 1, wherein
the video reproduction system is a digital video disc (DVD) system, and
the levels for restricting the reproduction of the video are parental levels in the DVD system.

3. The method of claim 1, wherein the determining of the viewing level further comprises determining the viewing level as a lowest age level in response to the input password not matching the passwords corresponding to the levels.

4. The method of claim 1, wherein the determining of the viewing level further comprises determining the viewing level as an upper level in response to the input password matching more than one of the passwords corresponding to the levels, wherein the upper level is a highest age level among all age levels of the levels corresponding to the input password.

5. The method of claim 1, wherein the viewing level determined is reset to a default viewing level in response to turning the video reproduction system off, wherein the default viewing level is one of a lowest age level set by an authorized user and a default age level set by a manufacturer of the video reproducing system.

6. An apparatus for controlling levels for restricting a reproduction of a video by a video reproducing system so as to restrict viewing of a part or all of the video depending on a user's age, comprising:
a memory which stores passwords corresponding to the levels; and
a controller which outputs a window to check an input password against the passwords in the memory prior to a reproduction mode, reads information including the levels corresponding to the input password to determine a viewing level from the memory, and controls the reproduction of the video according to the viewing level.

7. The apparatus of claim 6, wherein
the video reproduction system is a digital video disc (DVD) system, and
the levels for restricting the reproduction of the video are parental levels in the DVD system.

8. The apparatus of claim 6, wherein the controller determines the viewing level as a lowest age level in response to the input password not matching the passwords.

9. The apparatus of claim 6, wherein the controller determines the viewing level as an upper level in response to the input password matching more than one of the passwords corresponding to the levels, wherein the upper level is a highest age level among all age levels of the levels corresponding to the input password. levels for restricting viewing of the video depending on a user's age to be the level of the highest age in a case where the same passwords are set at two or more levels for restricting viewing of the video depending on a user's age.

10. The apparatus of claim 6, wherein the viewing level determined is reset to a default viewing level in response to turning the video reproduction system off, wherein the default viewing level is one of a lowest age level set by an authorized user and a default age level set by a manufacturer of the video reproducing system.

11. The method of claim 1, further comprising setting initial conditions for controlling the levels including:
designating a default viewing level to be used as the viewing level in response to one of an elapse of a predetermined wait period, entry of an incorrect input password and non-entry of the input password; and
selecting the predetermined wait period used by the video reproduction system to convert the viewing level to the default viewing level in response to one of a termination of the reproduction of the video and turning the video reproduction system off.

12. The method of claim 1, wherein the setting of the passwords comprises, one or a combination of, designating each of the passwords to a corresponding one of the levels and designating one of the passwords to a plurality of the levels.

13. The method of claim 1, wherein the reproducing of the video comprises:
reading reproduction data from the video having a level which is the same or lower than the viewing level determined; and
reproducing the reproduction data having the same or lower level than the viewing level.

14. The method of claim 1, wherein the determining of the viewing level further comprises determining the viewing level as a default viewing level in response to one of non-entry of the input password, elapse of a predetermined wait period and non-matching of the input password to the one or more passwords corresponding to the levels.

15. The method of claim 1, wherein the viewing level determined is reset to a default viewing level in response to one of turning the video reproducing system off and terminating the reproduction of the video.

16. A method of controlling levels for restricting a reproduction of a video by a video reproducing system so as to restrict viewing of a part or all of the video, the method comprising:
setting one or more passwords corresponding to the levels so as to control viewing of the video;
determining a viewing level prior to reproducing the video including verifying an input password against the one or more passwords set in the video reproducing system, wherein the viewing level is a level highest among all of the levels corresponding to the input password in response to the input password being consistent with the one or more passwords, and otherwise determining the viewing level as a default viewing level; and
reproducing the video according to the viewing level.

17. The method of claim 16, wherein the viewing level corresponding to the input password is converted to the default viewing level in response to one of turning the video reproducing system off, the passage of a predetermined wait period and terminating the reproduction of the video.

18. The method of claim 17, wherein the setting of the one or more passwords comprises, one or a combination of, designating each of the one or more passwords to a corresponding one of the levels and designating one of the one or more passwords to a plurality of the levels.

19. The method of claim 18, wherein the reproducing of the video comprises:
reading reproduction data from the video having a reproduction level which is the same or lower than the viewing level determined; and
reproducing the reproduction data having the same or lower level than the viewing level.

20. The method of claim 19, further comprising setting initial conditions for controlling the levels including:
designating the default viewing level to be used by the video reproducing; and
selecting the predetermined wait period used by the video reproduction system.

21. The method of claim 20, wherein
the video reproduction system is a digital video disc (DVD) system, and
the levels for restricting the reproduction of the video are parental levels in the DVD system.

22. A method of controlling levels for restricting a reproduction of a video by a video reproducing system so as to restrict viewing of a part or all of the video, the method comprising:
setting one or more passwords corresponding to the levels so as to control viewing of the video;
determining a viewing level prior to reproducing the video including verifying an input password against the one or more passwords set in the video reproducing system, wherein the viewing level is a level highest among all of the levels corresponding to the input password in response to the input password being consistent with the one or more passwords, and otherwise automatically determining the viewing as a default viewing level; and
reproducing the video according to the viewing level, wherein the viewing level corresponding to the input password is reset to the default viewing level in response to one of turning the video reproducing system off, an elapse of a predetermined wait period and terminating the reproduction of the video.

23. A method of controlling levels for restricting a reproduction of a video by a video reproducing system so as to restrict viewing of a part or all of the video, the method comprising:
setting one or more passwords corresponding to the levels including one or a combination of, designating each of the one or more passwords to a corresponding one of the levels and designating one of the one or more passwords to a plurality of the levels;
determining a viewing level in response to each instance of turning the video reproducing system on including verifying an input password entered after the each instance of turning on of the video reproducing system against the one or more passwords set in the video reproducing system, wherein the viewing level is a level highest among all of the levels corresponding to the input password in response to the input password being consistent with the one or more passwords, and otherwise automatically determining the viewing as a default viewing level; and
reproducing the video according to the viewing level.

24. An apparatus for controlling levels for restricting a reproduction of a video by a video reproducing system so as to restrict viewing of a part or all of the video, comprising:
a memory which stores data including one or more passwords corresponding to the levels so as to control viewing of the video; and
a controller which determines a viewing level prior to reproduction of the video and controls the reproduction of the video according to the viewing level, wherein the controller verifies an input password against the one or more passwords stored in the memory and determines the viewing level as a level highest among all of the levels corresponding to the input password in response to the input password being consistent with the one or more passwords, and otherwise the controller determines the viewing level as a default viewing level.

25. The apparatus of claim 24, wherein the viewing level corresponding to the input password is converted to the default viewing level in response to one of turning the video reproducing system off, the passage of a predetermined wait period and terminating the reproduction of the video.

26. The apparatus of claim 25, wherein the one or more passwords stored in the memory includes, one or a combination of, each of the one or more passwords corresponding to one of the levels and one of the one or more passwords corresponding to a plurality of the levels.

27. The apparatus of claim 26, wherein the controller reproduces the video by reading and reproducing reproduction data from the video having a reproduction level which is the same or lower than the viewing level determined by the controller.

28. The apparatus of claim 27, wherein
the video reproduction system is a digital video disc (DVD) system, and
the levels for restricting the reproduction of the video are parental levels in the DVD system.

29. An apparatus for controlling levels for restricting a reproduction of a video by a video reproducing system so as to restrict viewing of a part or all of the video, comprising:
a memory which stores data including one or more passwords corresponding to the levels so as to control viewing of the video; and
a controller which determines a viewing level prior to reproduction of the video, controls the reproduction of the video according to the viewing level and resets the viewing level to a default viewing level in response to one of turning the video reproducing system off, the passage of a predetermined wait period and terminating the reproduction of the video, wherein the controller verifies an input password against the one or more passwords stored in the memory and determines the viewing level as a level highest among all of the levels corresponding to the input password in response to the input password being consistent with the one or more passwords, and otherwise the controller automatically determines the viewing level as the default viewing level.

30. An apparatus for controlling levels for restricting a reproduction of a video by a video reproducing system so as to restrict viewing of a part or all of the video, comprising:
a memory which stores data including one or more passwords corresponding to the levels so as to control viewing of the video; and
a controller which determines a viewing level in response to each instance of turning on the video reproducing system and controls the reproduction of the video according to the viewing level, wherein the controller verifies an input password entered after the each instance of turning on of the video reproducing system against the one or more passwords stored in the memory and determines the viewing level as a level highest among all of the levels corresponding to the input password in response to the input password being consistent with the one or more passwords, and otherwise the controller automatically determines the viewing as a default viewing level.

31. A computer readable medium encoded with processing instructions for implementing a method of controlling levels for restricting a reproduction of a video so as to restrict viewing of a part or all of the video in a video reproduction system performed by a computer, the method comprising:
receiving one or more passwords corresponding to the levels so as to control viewing of the video;
determining a viewing level prior to reproducing the video including verifying an input password against the one or more passwords, wherein the viewing level is a level highest among all of the levels corresponding to the input password in response to the input password being consistent with the one or more passwords, and otherwise determining the viewing as a default viewing level; and
reproducing the video according to the viewing level.

32. The computer readable medium of claim 31, wherein the levels are included in a data set which comprises a parental table having, one or a combination of, each of the one or more passwords corresponding to each of the levels and one of the one or more passwords corresponding to a plurality of the levels.

33. The computer readable medium of claim 32, wherein the viewing level corresponding to the input password is converted to the default viewing level in response to one of turning the video reproducing system off, the passage of a predetermined wait period and terminating the reproduction of the video.

34. The computer readable medium of claim 33, wherein the reproducing of the video comprises:
reading reproduction data from the video having a reproduction level which is same or lower than the viewing level determined; and
reproducing the reproduction data having the same or lower level than the viewing level.

35. The computer readable medium of claim 34, further comprising receiving the default viewing level and the predetermined wait period used by the video reproduction system.

36. The computer readable medium of claim 34, wherein
the video reproduction system is a digital video disc (DVD) system, and
the levels for restricting the reproduction of the video are parental levels in the DVD system.

37. A computer readable medium encoded with processing instructions for implementing a method of controlling levels for restricting a reproduction of a video so as to restrict viewing of a part or all of the video in a video reproduction system performed by a computer, the method comprising:
receiving one or more passwords corresponding to the levels so as to control viewing of the video;
determining a viewing level prior to reproducing the video including verifying an input password against the one or more passwords set in the video reproducing system, wherein the viewing level is a level highest among all of the levels corresponding to the input password in response to the input password being consistent with the one or more passwords, and otherwise automatically determining the viewing as a default viewing level; and
reproducing the video according to the viewing level, wherein the viewing level corresponding to the input password is reset to the default viewing level in response to one of turning the video reproducing system off, the passage of a predetermined wait period and terminating the reproduction of the video.

38. A computer readable medium encoded with processing instructions for implementing a method of controlling levels for restricting a reproduction of a video so as to restrict viewing of a part or all of the video in a video reproduction system performed by a computer, the method comprising:
receiving one or more passwords corresponding to the levels so as to control viewing of the video;
determining a viewing level in response to each instance of turning the video reproducing system on including verifying an input password entered after the each instance of turning on of the video reproducing system against the one or more passwords set in the video reproducing system, wherein the viewing level is a level highest among all of the levels corresponding to the input password in response to the input password being consistent with the one or more passwords, and otherwise automatically determining the viewing as a default viewing level; and
reproducing the video according to the viewing level.
